(19) United States
(12) Patent Application Publication
(10) Pub. No.: US 2017/0132596 A1
(43) Pub. Date: May 11, 2017

(54) Digital Media Distribution Computer System

(71) Applicant: Richard Z. Whiffen, North Wales, PA (US)

(72) Inventor: Richard Z. Whiffen, North Wales, PA (US)

(21) Appl. No.: 14/936,659

(22) Filed: Nov. 9, 2015

(51) Int. Cl. G06Q 20/12; G06F 21/10

(52) U.S. Cl. CPC G06Q 20/1235; G06F 21/105; G06F 2221/0768; G06Q 2220/18

(57) ABSTRACT

The invention claimed is a digital media distribution system involving administration of digital copyright ownership registration and license purchase transactions of digital media under copyright licensure. Important aspects of the claimed invention presented include aspects such as user authentication methods, transaction administration methods and server features, and copyright protection mechanisms. The technical field pertaining to the claimed invention is described, and background information related to the claimed invention is given. Background considerations of digital copyright regarding propriety, legal implications, and ethical value of the claimed computer system invention utility are presented. Features and functions of two main types of system clients: a dedicated electronic device and a general-purpose personal computer software program, as well as ancillary types of clients are described in detail. Copyright registration and administration options for digital media distribution methods used by the claimed computer system invention are defined and described. System features related to transaction records and administration servers are described and claimed. Specific invention aspect claims are enumerated. Finally, terminology contemporary to information systems, data processing, and computing industries that are used in this patent document are clearly defined.

### TECHNICAL FIELD

The present patent document relates to a wide-area networked computers system of client devices and general purpose computer software instances operating on a peer-to-peer intercommunication basis with redundant system transaction data administration servers, client devices, and client software instances for the purpose of administering the distribution and licensed purchase sales of copyrightable digital media files through computer data communication networks. The type of invention disclosed primarily pertains to the already well defined and academically explored digital media distribution systems and methods classification called superdistribution; the specific new innovations and utility aspects original with this patent are clearly delineated in the claims section of the detailed description and specification.

### BACKGROUND

In respect of the intention of the invented systematized techniques and methods for administering and facilitating digital media copyright license purchase transactions, some attention to background regarding the economic, social, and ethical reasoning for copyrights may be helpful in understanding the purpose and utility of the claimed invention. The ideal embodiment of the disclosed computer system invention permits the convenience, computational resource, data communication efficiency, and other advantages of peer-to-peer digital media distribution while encouraging legal conformance to copyrights that are important economic incentive for the production of valuably informative, entertaining, and useful digital media. The disclosed computer system invention is not intended to replace existing United States or foreign copyright registration and administration organizations, instead it is intended to be operated by a for-a-reasonable-profit corporation, deferring ultimate recourse concerning copyright questions to those organizations, and operating in such a manner as to be able to provide clear and relevant data in a publicly transparent and respectful manner where necessary to appropriate government and industry association organizations regarding larger scale legal cases about specific copyrights.

Digital media piracy of software, music, motion pictures, and even print media has been a problem for digital media producers, and attempts to prevent such piracy have not progressed beyond the maintenance of complicated, often user-unfriendly, and unnecessarily redundant computational and data storage resource implementations that can place a significant technical and economic barrier of entry to digital media producers trying to market their digital productions for sale. Considered from the perspective of digital media consumers or purchasers, there are also problems with existing prevalent digital media copyright economics. Compare the purchase of a physical copy of a music recording such as a compact disc to the purchase of a digital media item. Most important to the topic here, once a digital media item is purchased, no further transactions of a purchased digital media item copy are typically permitted, whereas a physical copy of a music recording can be resold if the music recording is no longer wanted, or if a higher resale value can be realized. This line of reasoning, concomitant with other relevant considerations of information system theory was the basic motivation for the inventor's original conception of the computer system invention claimed here.

Given the copyright adherence reinforcing aspects of the disclosed system invention, it may be possible to avoid unnecessarily restrictive digital media copyright protection methods, permitting the use of a purchased digital media item on multiple devices as they are replaced or made available. This does, to some extent, amount to an honor system with an improved possibility of determining who is not observing legal copyright of a digital media file. For situations where a digital media item represents information that is potentially deleterious if misapplied or used maliciously, or when digital media producers simply prefer more stringent copyright protections, increased copyright protection methods are available within the claimed computer system invention as disclosed. For example, in the claimed computer system invention, digital media files can be published in proprietary formats that can only be displayed or read by proprietary software programs requiring cryptographic decryption keys that are separately generated by multiple aspects of the claimed computer system invention. When optionally employing such copyright protection for a digital media file, if the correct keys are not correctly obtainable by a proprietary purpose-designed media playback software program from the digital media files, user account, playback device, and other sources, the copyright protected digital media will not be accessible.

The most important claimed aspects of the disclosed invention are intended to help promote and reinforce individual awareness of copyright infringement concerns, and to promote awareness of economic concepts important to the beneficial functioning of an economically active society. Particularly, copyright adherence should be encouraged without unnecessarily involving harsh punitive measures in the case of small scale infringements, and in the case of large scale infringements, the copyright infringement tracking data derived from the operation of the claimed invention will allow law enforcement agencies and digital media producing industry associations additional information in the complicated arena of copyright infringement. Further, possibilities of unintentional complicity in copyright infringement require better tools, policies, and tact to help detect unintentional infringement and then encourage awareness of the problem without systematized inequality of policy enforcement.

### BRIEF DESCRIPTION OF THE DRAWINGS

FIG. 1. A depiction of a wide-area computer network highlighting internet service providers (labeled B, C, D, E, F, G), redundant transaction servers (labeled j, k, l), network communication appliances (labeled A, I, H), general purpose or dedicated device clients (labeled m through w), and two wireless networks of handheld computers (labeled x, y).

FIG. 2. A depiction of an example dedicated device including optional components.

FIG. 3. A simplified example graphical user interface for registering a new digital media item with the system.

FIG. 4. A simplified process overview of a digital media item purchase and single-source download transaction.

FIG. 5. A system state progression overview of a medium or large-sized digital media item purchase and multiple-source download transaction.

FIG. 6. An example search screen displaying an executed search and search results list.

FIG. 7. A somewhat abstract example of a weighted function of the claimed computer system invention for selecting which system client is selected from a large number of clients to transmit a digital media file and receive compensation through an example computer data communications network such as depicted in FIG. 1.

FIG. 8. A simplified depiction of a modular encrypted library stored on a digital data storage module

FIG. 9. An example process overview for screening digital media registrations for copyright infringement, content cautions and restrictions, and search meta-tagging reasonability.

### DETAILED SPECIFICATION

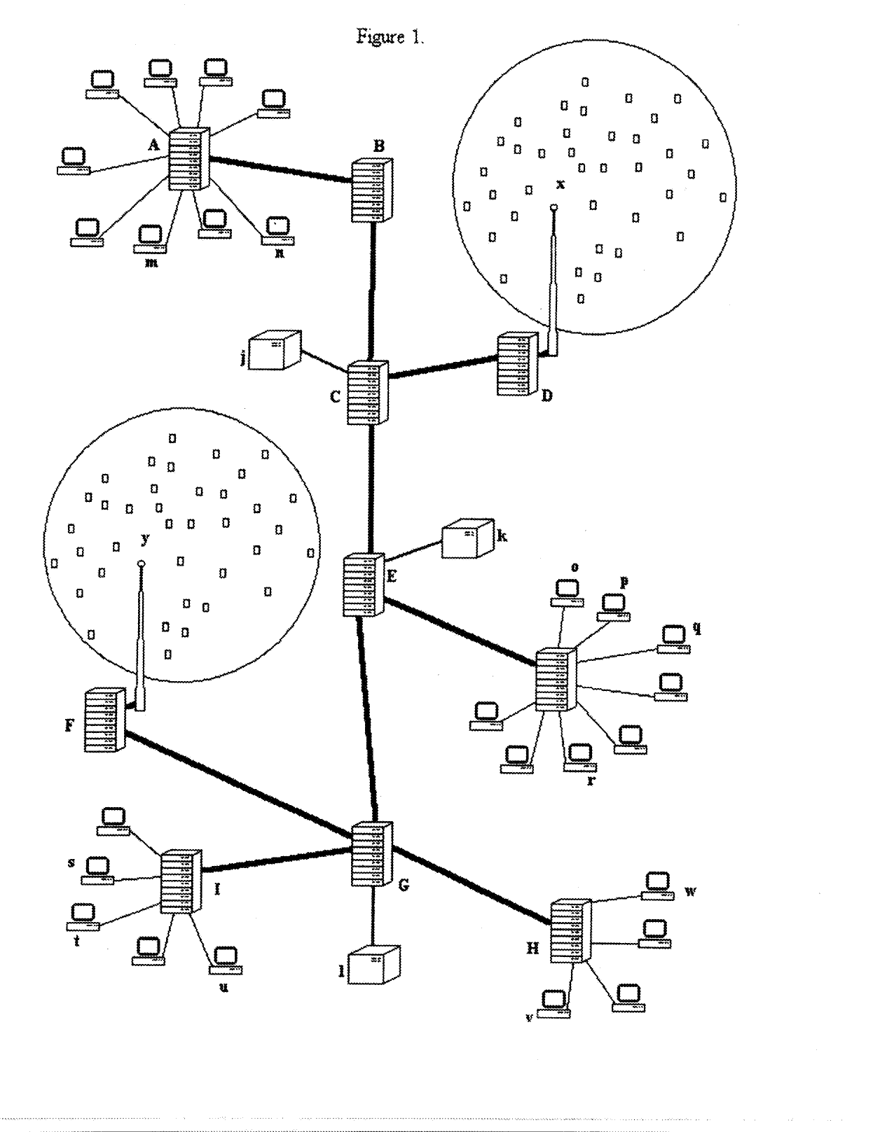

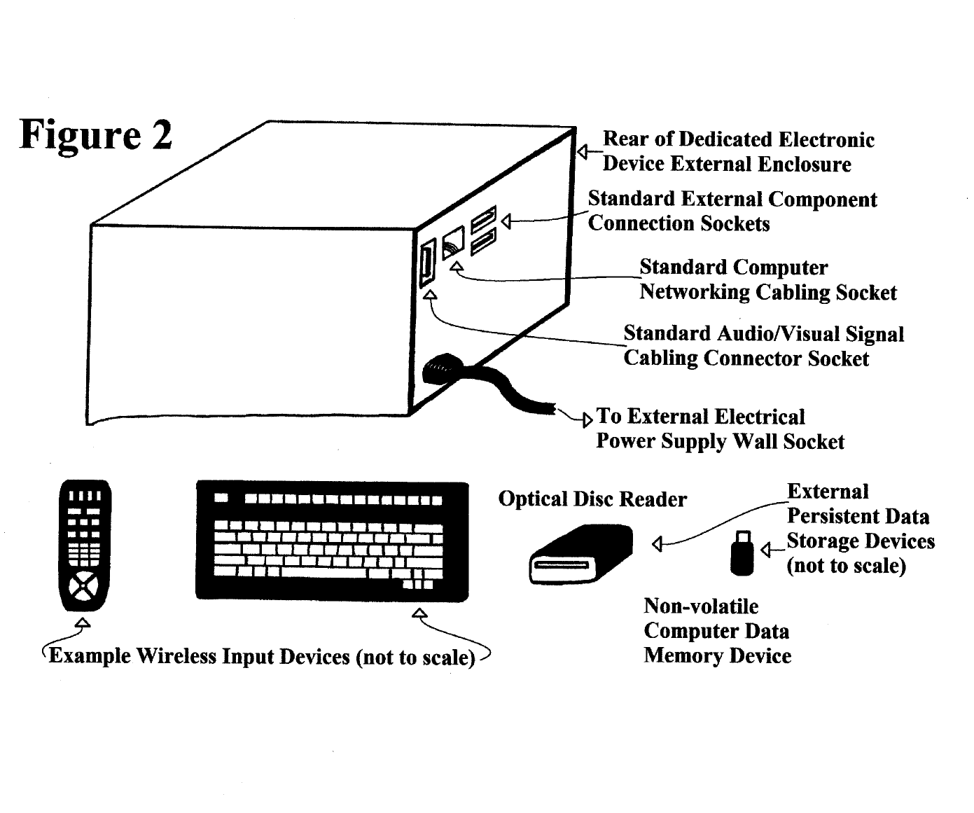

Referring to the included figures and drawings for illustrative examples, consideration of an example of a dedicated electronic device client depicted as system elements in FIG. 1 and individually in FIG. 2 will permit a better concrete description of the features and functions of a client instance of the claimed computerized network media distribution system invention. The features and functions of a dedicated electronic device client can then be understood to be duplicated in the features and functions of a claimed software program invention designed to run on general purpose personal computers and capable of performing the same basic functions as the described dedicated electronic device client. Details regarding some potential discrepancies between the two primary types of claimed computer system invention clients, along with additional considerations and claimed invention details will be described.

Shown in FIG. 2 is an example of a dedicated electronic device with audio/video output suitable for connection to an audio/video reproduction/display device such as a television or computer monitor. It also features a wired computer network socket for accepting computer network data, and any of several user input device designs. Optional physical components include wireless computer networking adapters, and persistent computer data storage device sockets for accepting data from offline libraries. Not explicitly depicted in FIG. 2 are interchangeable and replaceable data storage modules in the device behind a portion of removable exterior enclosure. The interchangeable and replaceable data storage modules are important because they allow expansion of a device's data storage capacity, replacement of faulty digital storage modules, and most importantly the purchase and subsequent installation of data storage modules with digital media already preloaded and pre-prepared for inclusion in a system client device user account owned digital library.

The computational tasks that a depicted described dedicated electronic device must be able to perform in order to function with the minimum capability as a client of the claimed computer system invention are enumerated next, but other additional useful functional capabilities are possible in an embodied example of the described dedicated electronic device system client. Required functional capabilities are capabilities to: 1) communicate with other clients and system servers through computer networks using computer data communication protocols already in widespread use, 2) calculate error-checking and authenticity-verifying checksums of received partial data file transmissions and complete digital media data files without interfering with other functional requirements, 3) store, transmit, and calculate data about network communication data speeds, 4) persistently store and quickly access large amounts of digital media data, 5) process or decrypt digital media for reproduction by a connected audio/visual device, 6) accept input from a user to perform searches for digital media and respond to data requests for digital media from system administration servers with same-device and other network node-state information related to network capability and device readiness to transmit requested data, 7) perform network device authentication validations, 8) perform user identification authentication validations, 9) interoperate with and transmit stored digital media data to ancillary system networked devices, 10) permit multiple users to maintain active accounts and store purchased digital media on the device, and 11) store data concerning transmissions of digital media data. General purpose personal computers in widespread contemporary use typically have the capability to be programmed to perform all of the just enumerated functions with a software program, however, the potentially security disruptive and often authenticity hostile program execution environment inherent in general purpose personal computers as well as the interact at large require additional capabilities such as operating system integration and safeguards against undesirable data integrity interference.

The type of dedicated electronic device depicted in FIG. 2, or an equivalent general-purpose computer software program should not be understood as the only type of client device capable of operation in association with the peer to peer network in the claimed computer system invention. Other classes of devices include portable entertainment electronics that might accept network data streams from a user's account managed device or dedicated network attached storage devices. The primary difference between these other classes of devices and dedicated electronic device system clients or general purpose computing device software programs are the ability to perform purchase transactions as well as the claimed invented system ability and method of performing digital media library content operations such as splitting an encrypted or non-encrypted library into multiple libraries for offline encrypted (or unencrypted if permitted by copyright license) storage, transport, or use on an approved non-system transaction capable client device.

A user account on the claimed computer system invention should be associable with any number of client devices, permitting the user to copy rightfully owned digital media between the different devices as permitted by the restrictions selected when the digital media was registered with the claimed computer system invention. Some media files that have been purchased by a user's account might be entirely removed from all account associated devices for digital storage space necessity. In such a situation, where an account is downloading a new copy of an already-purchased digital media file, the account should only be required to pay the transfer cost to get another copy, not the entire cost of a new purchase. Optionally, if a client device and user account owner has selected an appropriate preference, a client device might transmit a digital media file copy without monetary compensation and instead receive only system function credits, described further in the next paragraph. Alternative to completely deleting or overwriting digital media files on a device, the claimed computer system invention should permit the temporary storage of files in a compressed, password-protected, search and display access isolated manner.

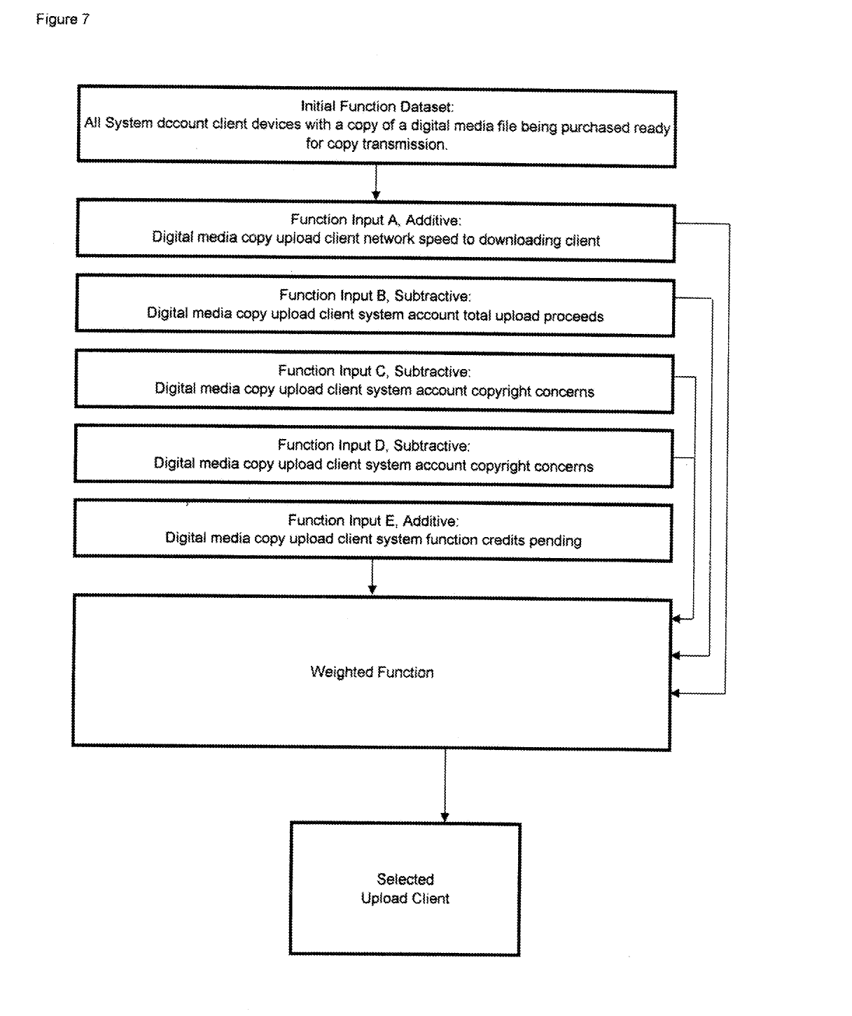

Concerning the concept of ‘system function credits’: system function credits in the claimed computer system invention are system client device owning user account-associated credits that are accrued for device completion of computation and other tasks by system client devices that do not necessarily merit monetary compensation because such tasks are not directly involved in a monetary transaction. The already given example of a system function credit worthy operation was the retransmission of a digital media file that was deleted or lost to data corruption. Other examples include responding to system queries for determining transmission speed capabilities, responding to search queries for specific items or genres of digital media, or responding to system queries for user ratings of digital media. The use of system function credits in methods of the claimed system invention operation is further detailed in the description of FIG. 7.

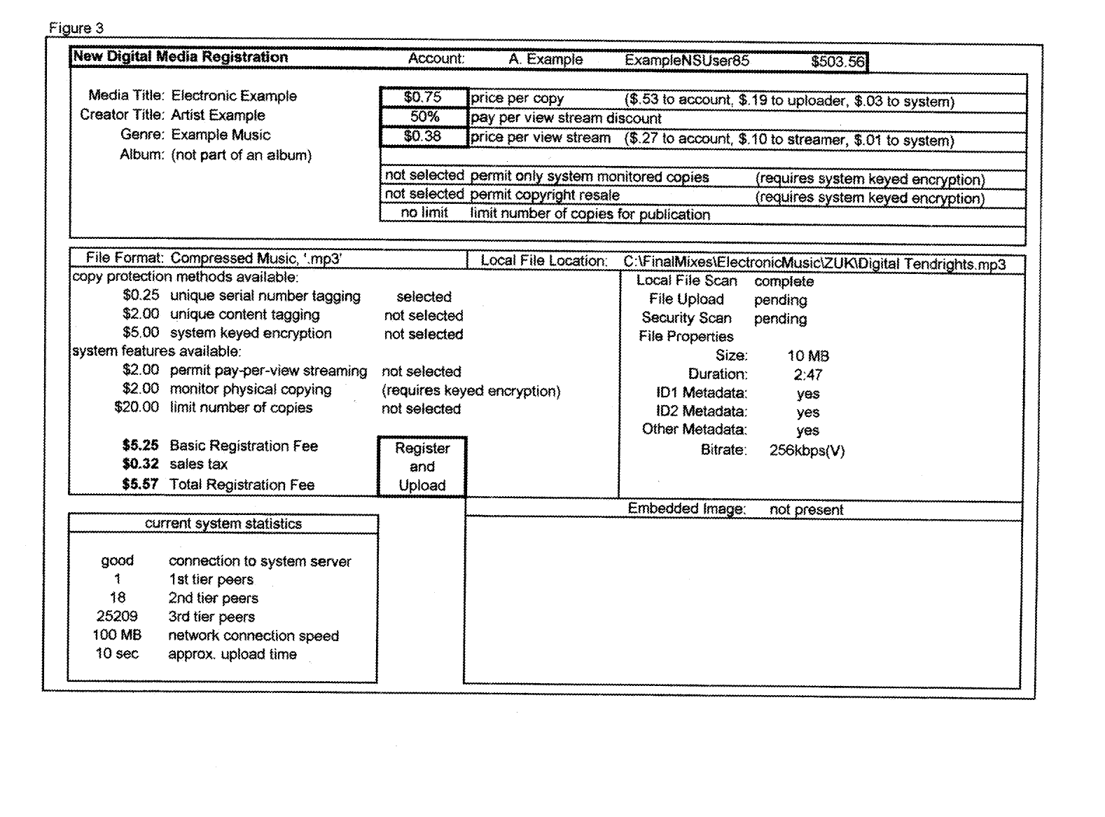

In the preferred implementation of the claimed invention, any instance of both main types of system client are expected to be able to register new digital media for copyright management and distribution through the claimed computer system invention, although additional qualifications concerning original ownership of digital media copyrights such as a minimal amount of publishing entity information on file associated with a system account will also be expected. FIG. 3 depicts a example user interface screen display design showing a digital media item, in this case a file representing a music recording of a song titled “Electronic Example”. Genre, artist name, and associated album data inputs are completed. Also completed are option specification inputs regarding purchase cost and other pricing related options, described further in more detail later. The depicted display indicates that the song file format is recognized by the system as one that permits the claimed system invention aspect for protecting copyright through individually purchased copies of the file through all of three of the different possible copyright monitoring methods, but that the registrant is not opting to register the song file using any of those. Those copyright methods depicted are described in the next paragraph.

The claimed computer system invention incorporates individual-file copy protection features as an important aspect of the disclosed invention claim. Such copy protection features affect the cost of registering the digital media due to the requirement of an additional amount of data processing each time the digital file is purchased. The first method is a simple header and/or tail section tag that marks each copy of a file with a simple and unique serial number. The second method, requiring more computational resources to calculate each time a media file is purchased, involves tagging each individual copy of a file purchased through the system with a unique series of small imperceptible changes of data bits comprising the actual media portion of the digital file, and recording what has been changed in a transaction database. The third method involves the system's encrypting some or all of a digital media file, thereby preventing the use of a digital media file without a digital key unique to each user's account on the claimed computer system invention. These methods can completely prevent the unauthorized use of a digital file, or at least allow later tracing of unauthorized copies of a digital media file back to an original purchaser, better enabling civil or criminal prosecution by the copyright owner as legal jurisdiction permits, and more importantly enabling other penalties restricted to the claimed computer system invention such as reducing the likelihood a copyright infringement-involved client device or software instance will be used as a source for future remunerable download purchases, or even complete revocation of a device client or user account system use license. It is important to note that the price depicted in FIG. 3 for purchasing a copy of the digital media being registered is specifiable by the copyright registration owner. Another important feature, available to a sufficiently secure client of the disclosed computer system invention such as the described dedicated electronic device, involves peer clients of the disclosed computer system invention being capable of serving digital media network streams, allowing for the one time playback of digital media files, dividing the stream cost between the digital media copyright owner and the owner of the client network streaming the digital media file. A so-purposed option checkbox is depicted in FIG. 3 permitting/restricting such digital media rental/streaming scenarios as the copyright owner registrant prefers. Note that the purchase cost price of $0.75 depicted in FIG. 3 is registrant-specified, many prices including $0.00 are acceptable in the described computer system invention. The digital download purchase recompense of claimed computer system invention device client user accounts should be considered to be fixed at a twenty five percent share of the full download purchase price once the registration is paid for, but that the transmission source compensation percentage can be set to the media registrant's preference until then.

Other options available when registering digital media for sale within the claimed computer system invention are the ability of a user to create copies of a digital media file. The registrant's selection for this option can either be to have user account client instances keep files encrypted in a client-monitored data storage format, or to store digital media files unencrypted on a general purpose computer persistent storage file system, permitting duplication to devices not necessarily originally designed for compatibility with the distributed copyright administration aspects of the claimed computer system invention. In the first digital media file storage option just described, the digital media registrant can specify the number of copies permitted to other devices associated with a user account on the claimed computer system invention. Copies might be deleted from unused devices to permit copy transfers to new or improved devices. As shown in FIG. 3, the system might also limit the total number of copies of a digital media file available in the system to increase the value of an individual digital media file copy.

The final digital file copyright registration described here pertains to the transferability of the file copyright license ownership; if a purchased digital file is found unsatisfactory for future use, unnecessarily large in digital storage, or unwanted for another reason, the claimed computer system invention can permit the user account to list the file and associated digital copyright for resale.

It should be understood that the digital media registration screen depicted in FIG. 3 is an example only and does not depict an exhaustive set of digital media file associated data that might be usefully specified for a digital media file being registered. An ideal embodiment of screen design as depicted in FIG. 3 will have design elements that vary depending on the type of digital media being registered, but the basic.

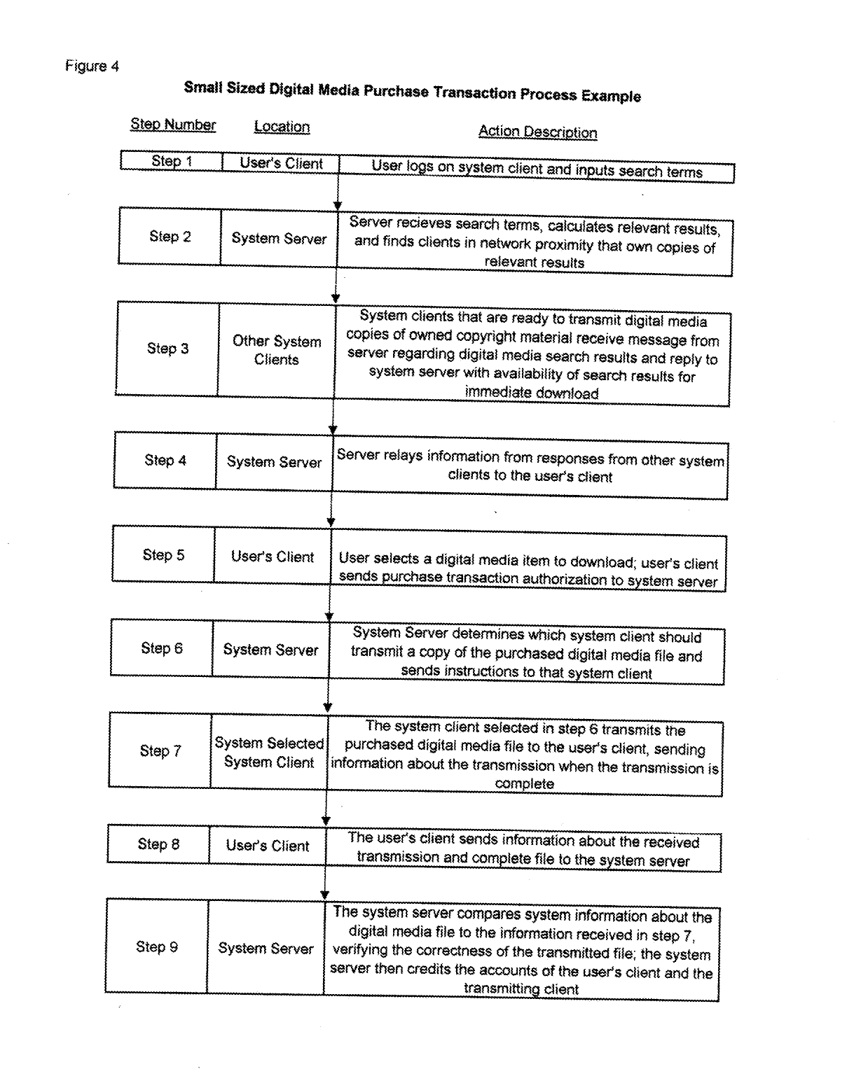

FIG. 4 depicts a media file purchase transaction process, including a step for the important system capability of the claimed computer system invention to check that a purchased digital media file has been transmitted correctly and without any errors or third-party interference using a checksum algorithm.

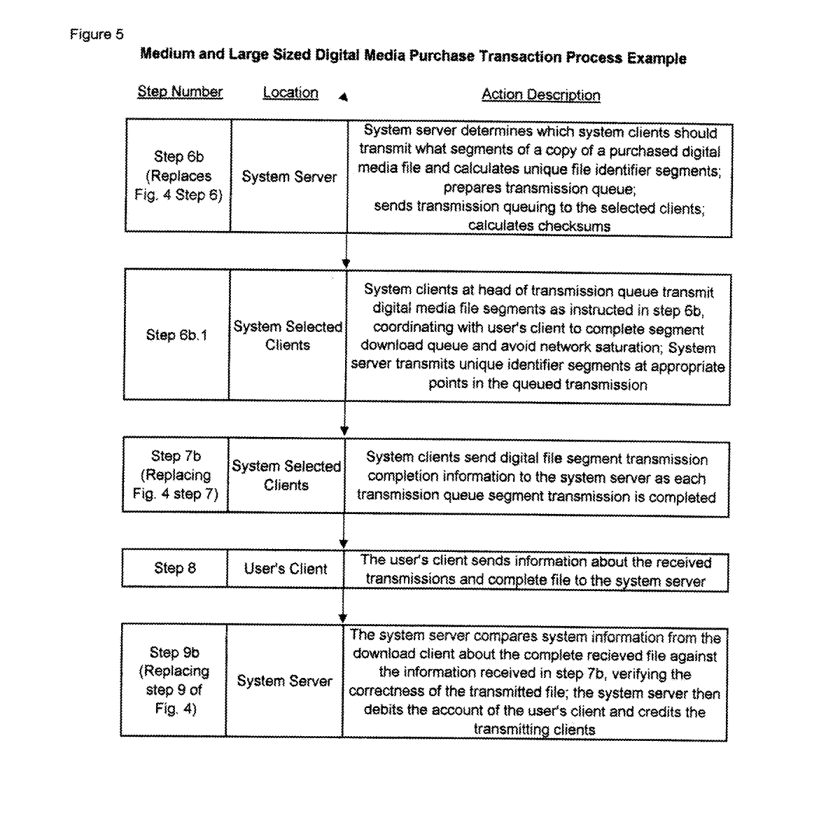

FIG. 5 depicts a media file purchase transaction similar to the transaction depicted in FIG. 4. The media file in FIG. 5 is significantly larger, and is being partially transmitted from multiple source clients to avoid problems derived from the often asymmetric upload/download speed available to internet service customers, as well as help ensure an accurate and protected copyright.

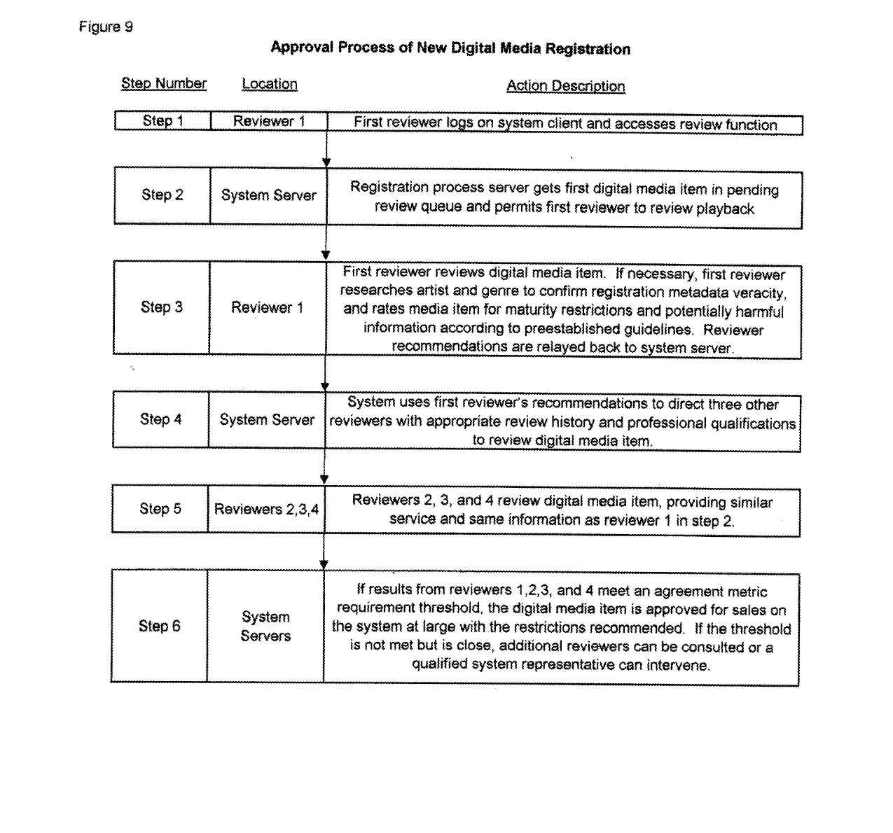

Not depicted in an illustrative figure diagram are the claimed computer system invention methods for adding monetary amounts to a user account balance for use in purchasing digital media files. The preferred method would be to use normal personal account credit cards for directly purchasing the equivalent system account credit as part of a digital media purchase transaction. In addition to that method, a person should be able to purchase a payment voucher at a retail store physical location, paying cash without having to use a credit card, optionally choosing to prove his or her age by presenting identification to receive an age verified redeemable voucher. The individual can then redeem the purchased payment voucher on the user's system client device, providing a positive balance for purchasing digital media. Such in-person purchases permit the added possibility of including increasingly inexpensive digital data storage modules with preloaded encryption key data, providing further data communication security than possible otherwise. In addition to permitting the basically anonymous user account operation, the claimed computer system invention also provides for restricting potentially harmful information to people qualified to work with such information. This media access restriction uses a process outlined in FIG. 9 which involves new digital media registration reviewers who identify mature content or potential harmful media, and user account owner qualification restrictions such as proof of a general education diploma or equivalent, ethics certifications, professional association endorsements, or academic degrees for accessing digital media that involves highly detailed description information pertaining to potentially very harmful activities.

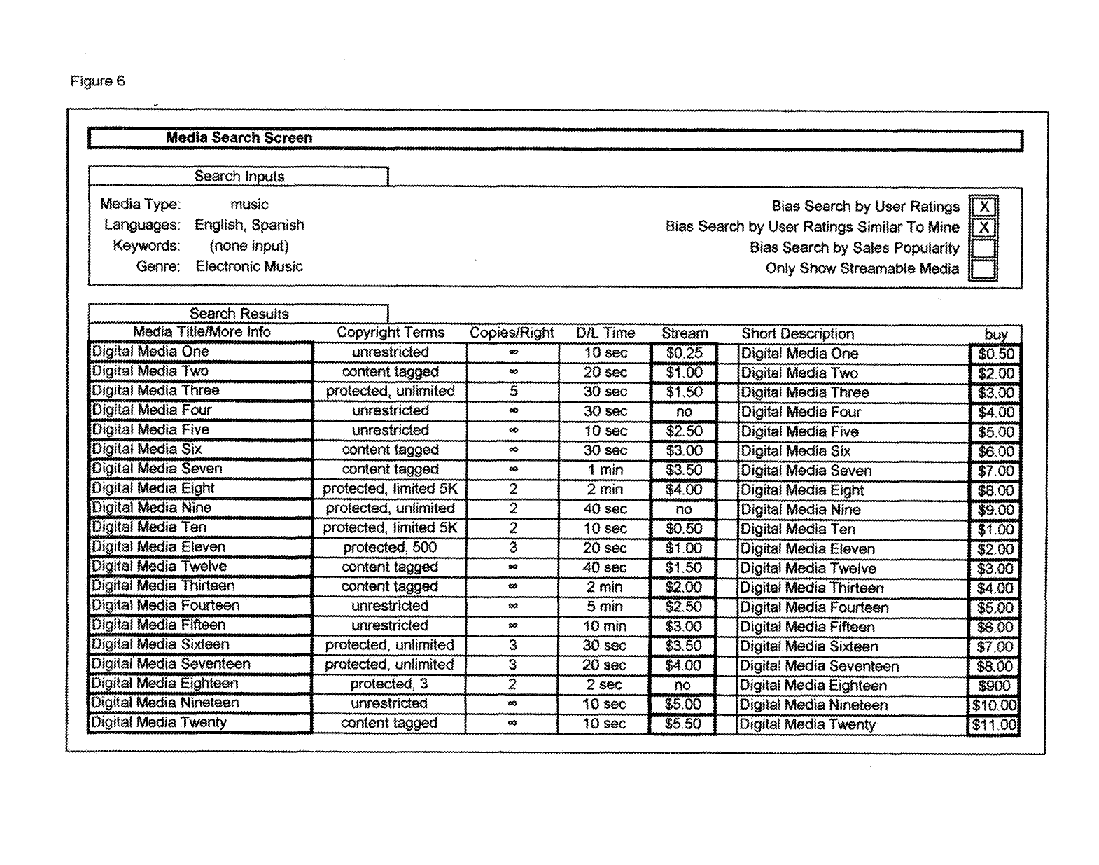

FIG. 6 depicts a media search screen display. Important search capabilities shown are the ability to bias search results towards media that have been positively rated by users who have rated other media similarly to the searching user's ratings in the searching user's library. It is not necessary that the media file be stored on a device creating the search that is selected for including user rating data as criteria, only the user rating data stored with the account data stored both on the user's devices as well as on system administration and transaction recording servers is required. Also note that FIG. 6 is not an example of an ideal search input and search results display screen, but is included to show how such a screen might be designed and what type of information display the claimed computer system invention is capable of generating.

FIG. 7 depicts a simplified weighted function calculated by a system server that is used to determine which system client device will be used as the source of a digital media purchase copy transmission and therefore receive account credit for originating the copy transmission. The weighted function starts by generating a list of all the user accounts with a legitimate copy of the digital media file being purchased that have a device online and ready to transmit a copy of the digital media file being purchased. The system then finds perhaps the top twenty five percent of client devices rated by the fastest network speed transmission from the potential copy transmission origin clients to the download purchasing client. Working from that subset; later referred to as subset A, the system server evaluates each potential origin client by three additional criteria. The first, labeled function input B removes the clients in subset A that have earned the most total digital file copy transfer credit, thereby avoiding a situation where certain clients are repeatedly and unfairly preferred by the claimed computer system invention as a result of a default preference caused by ordering clients by alphanumeric or other system behavior. Each of the result from function input A will have a weighted score as a result of the inputs from function inputs A and B, which is further affected by the weighted function using function input C, a system server calculated value regarding the past history of a user's account regarding copyright infringement, meaning that if uniquely identifiable copies of a digital media file associated with a user's account are found illegally distributed, the user's account-associated client devices will be less likely to be selected as a copy transmission origin client. Function input D works in a similar manner to the just-described function input C, selecting against system clients that are in close network proximity as determined by network communication speed which have a history of copyright infringement, and might have the added benefit of including historical data concerning network noise or interference metrics to help isolate those problems from transmissions or transaction decisions. Function input E increases selections for client device user accounts that have a greater number of system function credits.

As a result of all of the values from the A-E lettered function inputs depicted, a small subset of candidate digital media file copy transmission origination client devices is obtained. Of that subset, the client device with the best weighted function valuation is instructed by the system server to conduct the digital file copy transmission. If there is an identical weighted function value output between two or more potential copy transmission origination devices, the client associated with the user account having earned the least transmission origination credits could be used. If that amount is also identical, the device client user account with the earlier account establishment should be used to originate the digital media file copy transmission. In digital media file copyright purchase transactions that use multiple copy transmission client sources, any number of the top results from the weighted function abstraction just outlined can be used for the necessary digital file segment source clients.

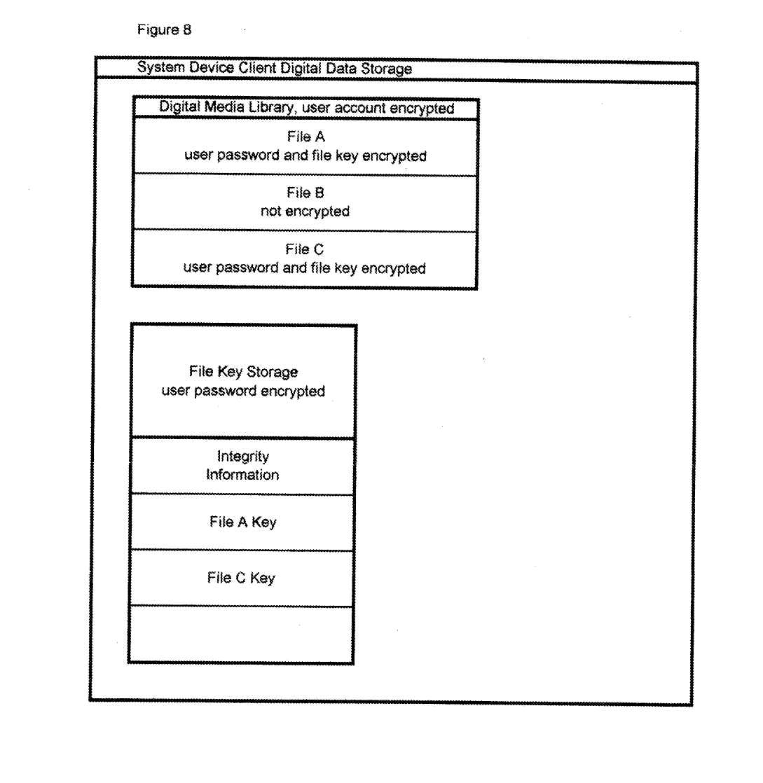

FIG. 8 is a simplified depiction of how the contents of a system client device data storage module might be cryptographically copy-protected with multiple levels of protection as necessary for the different copyright protection options described above. An entire library can be stored as a single encrypted file, making it less vulnerable to bulk copy, transfer, and unauthorized decryption. For digital media registrations not requiring copyright protection, only the user account password is necessary to access the persisted digital media library. For stronger copyright protection, as few as three keys are required at various stages of the decryption access process: the user account password, the client device specific key, and the file key. When a user selects for access to a digital media file, the user's system account password acts the first of two cryptographic keys necessary to decrypt the File Key Storage, the other key being uniquely stored as part of the system client device and external to the modular data storage. The necessary stored file key, in combination with either both the device and user account keys or just the user account key, depending upon the copyright protection encryption level selected, is then used to decrypt a specific file out of the library. This three-key system (user account password, client device stored key, and file key) allows greater security of digital media library contents, and permits separation of files from one library into another without necessarily requiring re-encryption of individual files for inclusion in a new digital media library, and further requires authorization from the claimed system invention for transfer of a copyright protected digital media item from one system client device to a second system client device in order to transfer and store the file decryption key with the second system client device's unique Client Cryptographic Key store.

FIG. 9 depicts the new registration approval process for a digital media item submitted for sale on the claimed computer system invention.

### Terminology

Client—in contemporary information technology industry vocabulary, the term ‘client’ can mean several different things, in this patent document, the term is used to identify a physical device or a computer software program intended to accept instruction input from a user or comparably input-capable software agent, and perform computation tasks according to those instructions that include calculations, data display, and data communication with servers and other clients.

Digital Media—any of a myriad of digital file formats representing text, music, video, software program instructions or other numerically encoded representations of physical phenomena.

Digital Media Registrant—an individual or organization claiming copyright ownership of a copyrightable digital media under terms specified by option selections made when a digital media property is registered and uploaded for distribution on the claimed computer system invention.

Dedicated Purpose Electronic Device—an electronic device designed and manufactured to primarily perform a specific set of data input processing, data display, or other tasks, without being easily adaptable or reprogrammable to perform other tasks. One example of a dedicated electronic device in widespread contemporary use is a home entertainment video game console.

General Purpose Personal Computer—an electronic computing device'designed and manufactured to be able to run or execute a wide variety of computer software programs, often also has modular part design.

Node—in this document refers to an addressable device on a computer network such as a computer, printer, dedicated display device, dedicated electronic device, or server.

Peer-to-peer networking—in a basic embodiment, a type of computer networking software that allows a software user to send a search request for digital media or other computer files to a large number of other computer devices running a similar software program which then respond to the search issuing computer with lists of files relevant to the search request that are available for copy transmission through the computer network. The software user can then select a desired digital file from the list of returned search results and request the computer with the desired digital file begin transmitting a copy of that file.

Persistent Storage—computer data storage that either does not require electrical power or retains stored data after removal and reapplication of an external electrical power supply.

Digital Media Producer—either an individual person or an organized group of people who create digital media files for publication and/or license sale.

Server—in this patent document, a server means a computer intended primarily to receive, process, and transmit data from/to other computers, especially clients.

User Account—in this patent document refers to a set of data on the claimed computer system invention that comprises a record of the digital media items purchased, the display/playback and data storage devices associated with the user account authorized to access, display, and participate in recompensed distribution of purchased digital media items, a monetary account balance, and cryptographic keys necessary for use of strongly copyright-protected digital media.

1. A system and method of networked computing devices including general purpose personal computers, dedicated purpose electronic devices, and geographically diverse redundant system servers used to register digital media files for purchase by user accounts that are individually authenticated and either anonymously credentialed, minimally credentialed, or formally credentialed by customary electronic financial system credit transaction records or interchangeable digital data storage modules preloaded with unique encryption key data or digital media pre-prepared for integration into a digital media library and involving:
methods for registering digital media copyright licenses for sale with the following copyright license options and variably calculating a copyright registration price based on the options selected, each of which should be understood to also require a further option specification to either restrict the number of authorized copies or allow an unlimited number of authorized copies:
with no copyright protection,
with individually numbered metadata or individually content tagged copies, or
with user account restricted copyright protection requiring three decryption keys: account, device, and file key;
methods for specifying the following redistribution and copyright license options of digital media during digital media registration, and calculating copyright registration price based upon the combination of following options selected:
custom copy transmission source redistribution compensation rate,
deletion of purchased media with purchase price refund for a limited or unlimited time from purchase,
transferable or non-transferable copy ownership license,
recompensed stream transmission from a system client device,
restricting media purchase by system user accounts used on safeguards on mature or potentially hazardous information content;
methods of anonymously purchasing system account balance credit offline, verifying user's age for restricting purchase of mature or otherwise potentially harmful content, and systematic requirement of registered qualifications of users for restricting purchase and access to potentially hazardous content;
and methods for validation of newly registered digital media item content by history tracked professional digital media reviewers for correct copyright ownership attribution, restriction ratings, and search convenience tags.

2. A system implementation and methods of networked computing devices and system servers for deterministically selecting a digital media copy transmission source from a plurality of possible system clients using a computer algorithm involving any of the following criteria:
user preference, data communication computer network transmission speed performance metrics, individual user account copyright adherence metrics, geographic area copyright adherence metrics, and system data processing task completion credit metrics.

3. Methods for searching for a digital media items offered for purchase by search biasing results based on inputs such as user ratings, contents of libraries with similar user ratings on digital files owned by the searching account, digital media popularity, and system features and copyright license options.
